(19) United States
(12) Patent Application Publication
(10) Pub. No.: US 2007/0051321 A1
(43) Pub. Date: Mar. 8, 2007

(54) Aquarium cover having an extendible and retractable extension cover member

(76) Inventor: Ching-Feng Chang, Taipei Hsien (TW)

Correspondence Address: BANNER & WITCOFF, 1001 G STREET N W, SUITE 1100, WASHINGTON, DC, 20001, US

(21) Appl. No.: 11/219,862

(22) Filed: Sep. 7, 2005

(51) Int. Cl. A01K 63/06

(52) U.S. Cl. 119/266

(57) ABSTRACT

An aquarium cover includes a main cover body adapted to cover a portion of a top opening of an aquarium and having two opposite lateral sides, and an extension cover connected to the main cover body and adapted to cover a remaining portion of the top opening. The extension cover includes at least one extension cover member connected slidably and overlappingly to the main cover body and movable in a first direction away from the corresponding lateral side so as to extend to a closing position and in a second direction so as to retract to an opening position. A slide mechanism is provided on the main cover body and the extension cover for sliding movement of the extension cover relative to the main cover body, and includes a slide groove and a slide member sliding along the slide groove.

### BACKGROUND OF THE INVENTION

1. Field of the Invention

The invention relates to an aquarium cover, more particularly to an aquarium cover that has an extendible and retractable extension cover member.

2. Description of the Related Art

Referring to FIG. 1, a conventional aquarium cover is mounted on top of an aquarium 4, and includes a main cover body 91, and a hinged cover portion 92 connected to the main cover body 91. When the hinged cover portion 92 is turned upward and then pivoted downward to rest on the main cover body 91, a portion of a top opening in the aquarium 4 is uncovered. In this state, dust and dirt may accumulate on an inner face of the hinged cover portion 92, such that when the hinged cover portion 92 is moved to cover the top opening in the aquarium 4, the dust and dirt fall from the hinged cover portion 92 and enter the aquarium 4.

### SUMMARY OF THE INVENTION

Therefore, the object of the present invention is to provide an aquarium cover that has extension cover members which are extendible and retractable so as to adjust a desired portion of a top opening in an aquarium to an opening or a closing position, thereby preventing a situation where dust and dirt accumulated on the extension cover members enter the aquarium.

According to this invention, an aquarium cover for covering a top opening of an aquarium comprises a main cover body, an extension cover, and a slide mechanism. The main cover body is adapted to cover a portion of the top opening of the aquarium, and has two opposite lateral sides. The extension cover is connected to the main cover body, and is adapted to cover a remaining portion of the top opening. The extension cover includes at least one extension cover member connected slidably and overlappingly to the main cover body and movable in a first direction away from one of the lateral sides so as to extend to a closing position and in a second direction opposite to the first direction so as to retract to an opening position. The slide mechanism is provided on the main cover body and the extension cover for sliding movement of the extension cover relative to the main cover body, and includes a slide groove and a slide member sliding along the slide groove.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a conventional aquarium cover mounted on an aquarium;

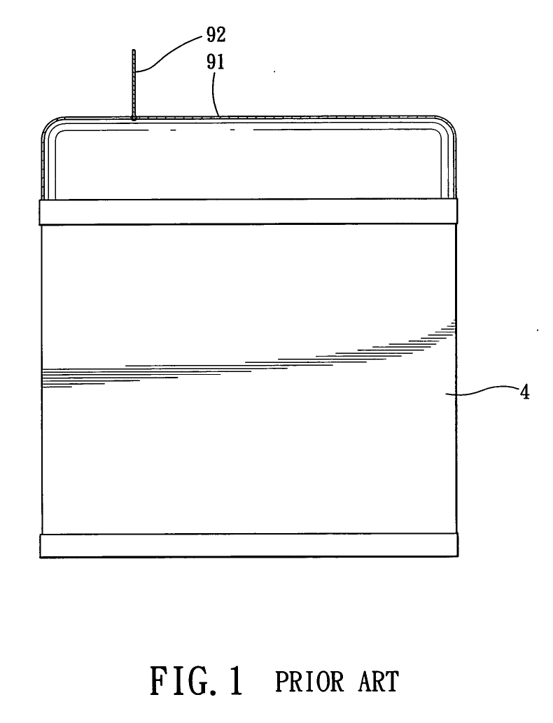

FIG. 2 is a perspective view of an aquarium which incorporates an aquarium cover embodying the first preferred embodiment of the present invention;

FIG. 3 is an exploded bottom perspective view of the first preferred embodiment;

FIG. 4 is a fragmentary schematic view of the first preferred embodiment, illustrating two extension cover members in a closing position;

FIG. 5 is a view similar to FIG. 4, but illustrating the extension cover members in an opening position;

FIG. 6 is a schematic view, illustrating the extension cover members in a partial opening position;

FIG. 7 is a schematic view of the second preferred embodiment of an aquarium cover according to the present invention; and

FIG. 8 is a schematic view of the third preferred embodiment of an aquarium cover according to the present invention.

### DETAILED DESCRIPTION OF THE PREFERRED EMBODIMENTS

Before the present invention is described in greater detail, it should be noted that like elements are denoted by the same reference numerals throughout the disclosure.

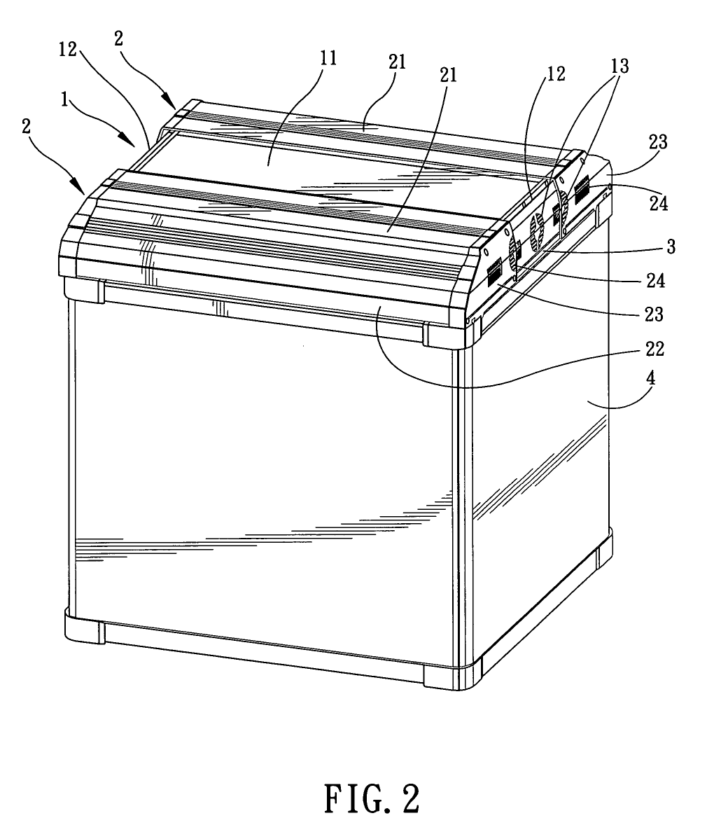

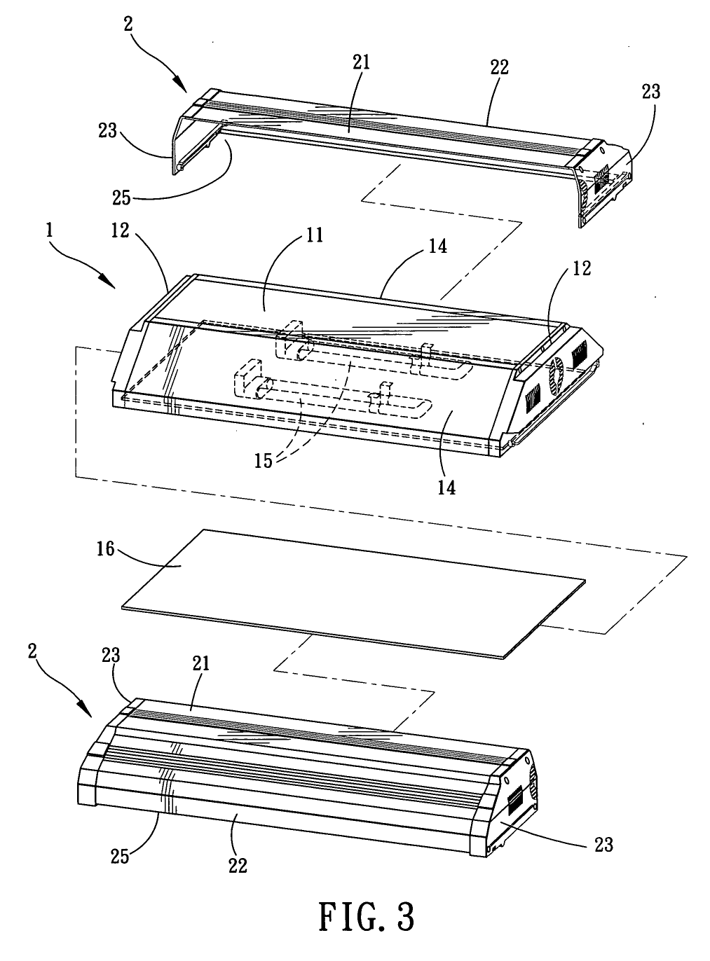

Referring to FIGS. 2 to 5, the first preferred embodiment of an aquarium cover according to the present invention is adapted to cover a top opening of an aquarium 4, and is shown to comprise a main cover body 1, an extension cover, and a slide mechanism 3.

The main cover body 1 has a trough-like shape, and is adapted to be mounted on a central top portion of the aquarium 4 to cover a portion of the top opening thereof. The main cover body 1 includes two opposite first lateral sides 14, a first top wall 11 interconnecting the first lateral sides 14, a pair of second lateral sides 12 interconnecting the first lateral sides 14 and connected to the first top wall 11, an illuminating unit 15 disposed in a space confined by the first and second lateral sides 14, 12 and the first top wall 11, and a waterproof transparent bottom cover 16 disposed opposite to the first top wall 11 and connected to the first and second lateral sides 14, 12.

The extension cover is connected to the main cover body 1, and is adapted to cover a remaining portion of the top opening in the aquarium 4 not covered by the main cover body 1. In this embodiment, the extension cover includes a pair of extension cover members 2. However, in an alternative embodiment, the extension cover may include only one extension cover member 2. The extension cover members 2 are connected slidably to and are extendible respectively from the first lateral sides 14 of the main cover body 1. Each of the extension cover members 2 includes a second top wall 21 overlapping the first top wall 11, a pair of third lateral sides 23 connected respectively to two opposite ends of the second top wall 21 and overlapping respectively the second lateral sides 12, a fourth lateral side 22 connected to and extending downwardly and inclinedly from the second top wall 21 and interconnecting the third lateral sides 23, and a bottom open end 25 opposite to the second top wall 21. The second and third lateral sides 12, 23 are formed with a plurality of vent holes 13, 24 for heat dissipating purposes.

The slide mechanism 3 is provided on the second lateral sides 12 proximate to the bottom cover 16 and on the third lateral sides 23 of each extension cover member 2 proximate to the corresponding bottom open end 25 for sliding movement of the extension cover members 2 relative to the main cover body 1. The slide mechanism 3 includes a slide groove 31 provided in each of the second lateral sides 12, and a slide member 32 provided on each third lateral side 23 of each extension cover member 2. The slide groove 31 in each of the second lateral sides 12 is substantially parallel to the bottom cover 16. In this embodiment, the slide member 32 is formed as a ridge 320 that projects from the corresponding third lateral side 23 to extend into and slide along the corresponding slide groove 31. The slide groove 31 in each of the second lateral sides 12 has a cross section larger than that of the ridge 320.

Each of the second lateral sides 12 of the main cover body 1 is further provided with two spaced-apart first cylindrical guides 311 in the slide groove 31 thereof to guide the ridge 320 on each third lateral side 23 to slide smoothly and stably along the corresponding slide groove 31. The first cylindrical guides 311 are located proximate to the third lateral sides 23. The ridge 320 contacts the first cylindrical guide 311 and one side of a groove wall of the corresponding slide groove 31 when sliding along the corresponding slide groove 31. Each third lateral side 23 of each of the extension cover members 2 is further provided with a second cylindrical guide 321 projecting into and slidable along the slide groove 31 in the corresponding second lateral side 12 and spaced apart from the corresponding first cylindrical guide 311. Each of the first and second cylindrical guides 311, 312 is preferably formed as a roller.

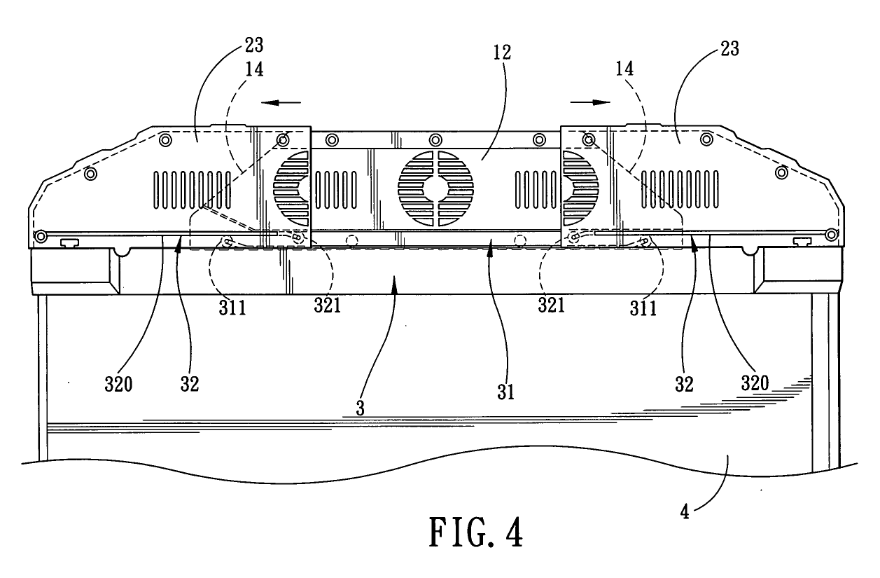

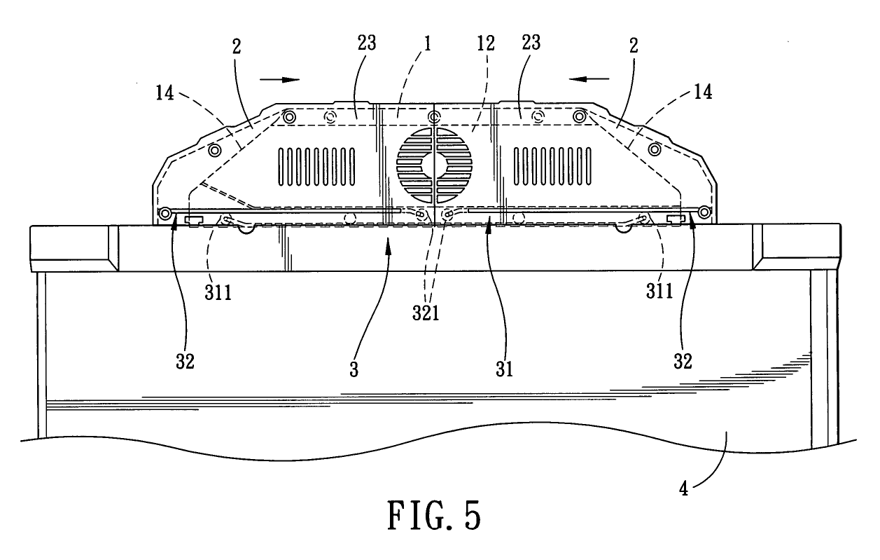

Through the slide mechanism 3, the extension cover members 2 can be moved in a first direction and a second direction opposite to the first direction. In the first direction, the extension cover members 2 move away from the corresponding first lateral sides 14 so as to extend to a closing position, as shown in FIGS. 2 and 4, thereby covering the portions of the top opening in the aquarium 4 not covered by the main cover body 1. In the second direction, the extension cover members 2 move toward the corresponding first lateral sides 14 so as to retract to an opening position, as shown in FIG. 5, thereby exposing the portions of the aquarium top opening that are not covered by the main cover body 1. The extension cover members 2 overlap the main cover body 1 in this state.

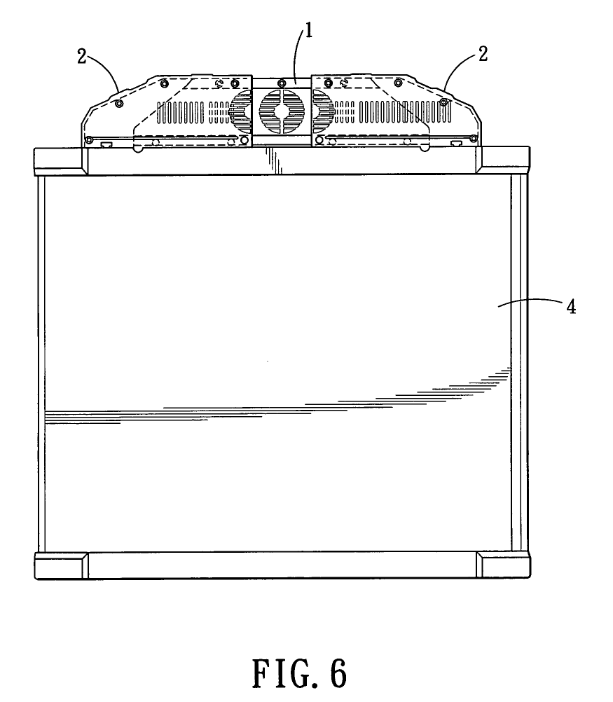

Alternatively, the extension cover members 2 may be moved to a position between the closing and opening positions, as shown in FIG. 6, so as to expose small portions of the top opening in the aquarium 4 to facilitate feeding of fish, cleaning of the aquarium 4, etc. As desired, one may move only one of the extension cover members 2 to the opening position so as to expose the portion of the top opening covered by the corresponding extension cover member 2.

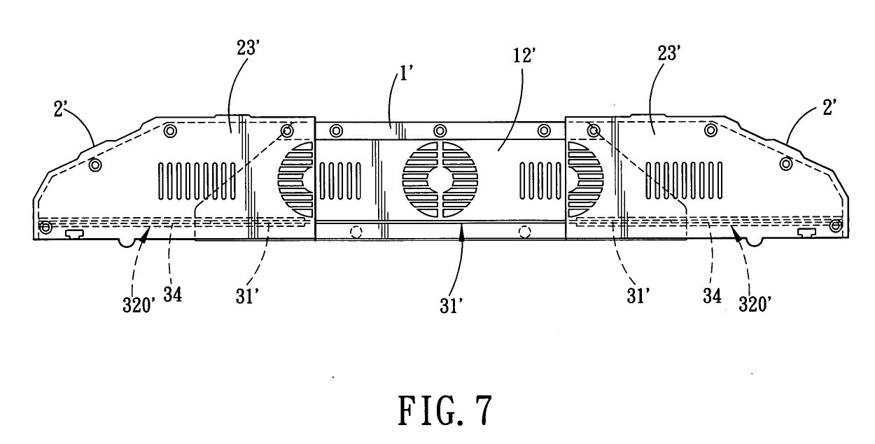

Referring to FIG. 7, the second preferred embodiment of an aquarium cover according to the present invention is shown to be similar to the first preferred embodiment. However, in this embodiment, each of the second lateral sides 12′ of the main cover body 1′ is provided with a ridge 31′ instead of the slide groove 31. The ridge 31′ projects outwardly from an outer face of the corresponding second lateral side 12′. Each of the third lateral sides 23′ of each extension cover member 2′ is provided with a pair of parallel ridges 320′ that project inwardly from an inner face of the corresponding third lateral side 23′ and that define therebetween a slide groove 34 for sliding movement of the corresponding ridge 31′ therealong.

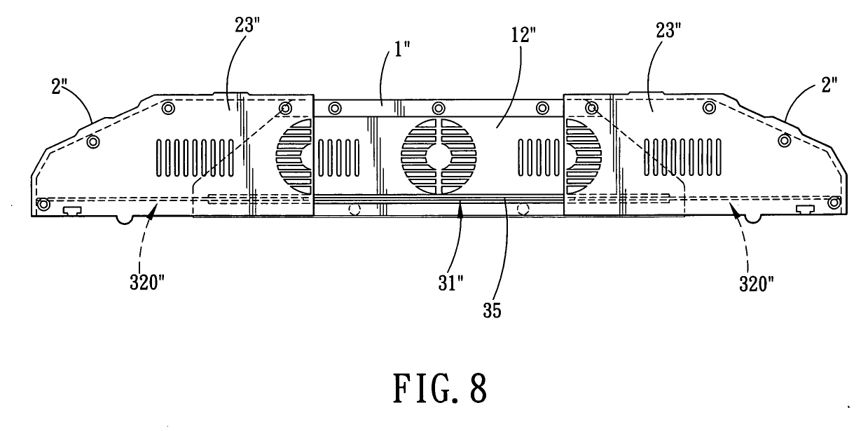

Referring to FIG. 8, the third preferred embodiment of an aquarium cover according to the present invention is shown to be similar to the second preferred embodiment. However, in this embodiment, each of the second lateral sides 12″ of the main cover body 1″ is provided with a pair of parallel ridges 31″ that define therebetween a slide groove 35. Each of the third lateral sides 23″ of each extension cover member 2″ is provided with only one ridge 320″ that slides along the corresponding slide groove 35.

From the aforementioned description, it is apparent that due to the provision of the slide mechanism 3 in the aquarium cover of the present invention, the extension cover members 2 are movable between the closing and opening positions so as to cover or expose the desired portion of the top opening in the aquarium 4. As a result, dust and dirt that may accumulate on the extension cover members 2, 2′, 2″ do not enter the aquarium 4.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An aquarium cover for covering a top opening of an aquarium, comprising:
a main cover body adapted to cover a portion of the top opening of the aquarium and having two opposite first lateral sides;
an extension cover connected to said main cover body and adapted to cover a remaining portion of the top opening, said extension cover including at least one extension cover member connected slidably and overlappingly to said main cover body and movable in a first direction away from one of said first lateral sides so as to extend to a closing position and in a second direction opposite to said first direction so as to retract to an opening position; and
a slide mechanism provided on said main cover body and said extension cover for sliding movement of said extension cover relative to said main cover body, said slide mechanism including a slide groove and a slide member sliding along said slide groove.

2. The aquarium cover of claim 1, wherein said main cover body includes a first top wall interconnecting said first lateral sides, a pair of second lateral sides interconnecting said first lateral sides and connected to said first top wall, an illuminating unit disposed in a space confined by said first and second lateral sides and said first top wall, and a transparent bottom cover disposed opposite to said first top wall and connected to said first and second lateral sides.

3. The aquarium cover of claim 2, wherein said extension cover member includes a second top wall overlapping said first top wall, a pair of third lateral sides overlapping respectively said second lateral sides, a fourth lateral side connected to said second top wall and interconnecting said third lateral sides, and a bottom open end opposite to said second top wall, said fourth lateral side being moved away from said one of said first lateral sides in said closing position.

4. The aquarium cover of claim 3, wherein said slide mechanism is provided on said second and third lateral sides proximate to said bottom cover of said main cover body and said bottom open end of said extension cover member.

5. The aquarium cover of claim 4, wherein each of said second lateral sides has said slide groove substantially parallel to said bottom cover, each of said third lateral sides having said slide member projecting therefrom to extend into said slide groove.

6. The aquarium cover of claim 5, wherein said slide member is formed as a ridge extending along said slide groove.

7. The aquarium cover of claim 6, wherein said slide groove has a cross section larger than that of said ridge, each of said second lateral sides further having a first cylindrical guide projecting therefrom into said slide groove to guide said ridge.

8. The aquarium cover of claim 7, wherein each of said third lateral sides further has a second cylindrical guide projecting therefrom into said slide groove to slide in said slide groove.

9. The aquarium cover of claim 4, wherein each of said second lateral sides has said slide member, each of said third lateral sides having said slide groove for sliding of said slide member.

10. The aquarium cover of claim 9, wherein said slide member is formed as a ridge extending along said slide groove.

11. The aquarium cover of claim 1, wherein said second and third lateral sides are formed with vent holes.

12. The aquarium cover of claim 1, which comprises a pair of said extension cover members which are extendible from said first lateral sides, respectively.
